(19) United States
(12) Patent Application Publication
(10) Pub. No.: US 2011/0164367 A1
(43) Pub. Date: Jul. 7, 2011

(54) Notebook Computer with Heating Function

(75) Inventor: Wen-Hung Huang, Taipei County (TW)

(73) Assignee: HANNSPREE, INC., Taipei City (TW)

(21) Appl. No.: 12/749,845

(22) Filed: Mar. 30, 2010

(30) Foreign Application Priority Data
Jan. 6, 2010 (TW) 099100210

(51) Int. Cl. G06F 1/16

(52) U.S. Cl. 361/679.09; 361/679.26

(57) ABSTRACT

The present invention relates to a notebook computer with a heating function, which comprises an operation unit; a display unit coupled to a first side of the operation unit; a main body coupled to a second side of the operation unit, wherein the second side is opposite to the first side. The main body has a platform, and the platform has an electromagnetic heating unit. The operation unit can be moved to a first position to enable food to be stably placed on the platform and heated by the heating unit. The operation unit can also be moved to a second position to contact the main body.

### BACKGROUND OF THE INVENTION

1. Field of the Invention

The present invention relates to a portable computer, particularly to a notebook computer artfully integrated with a heating unit, whereby the user can heat or cook food with the heating unit.

2. Description of the Related Art

For a person living in an apartment with limited space, he can only furnish his room with indispensable furniture and electric appliances.

For a frequently-mobile computer user, a notebook computer is an indispensable device for the user to use.

For a small living or working space, the induction cooker is a popular device because it is compact, portable and able to cook food fast and conveniently.

Therefore, the notebook computer and the induction cooker have become indispensable devices for many students and tenants.

### SUMMARY OF THE INVENTION

The primary objective of the present invention is to provide a notebook computer with a heating unit, wherein the notebook computer shares the common components with the heating unit, whereby a notebook computer not only can function as a computer but also can heat and cook food, and whereby both the notebook computer and heating unit are integrated into a single device.

Another objective of the present invention is to provide a notebook computer with a heating function, whereby a notebook computer owner can heat or cook food with the built-in heating function, and whereby can be saved the space occupied by an induction cooker.

To achieve the abovementioned objectives, the present invention proposes a notebook computer with a heating function, which comprises an operation unit; a display unit connected to a first side of the operation unit and able to be lifted up from or folded down onto the operation unit; a main body having a notebook computer processing system and a heating unit control system, connected to a second side of the operation unit, and containing a platform with a heating unit,

wherein the second side of the operation unit is opposite to the first side of the operation unit, and
wherein the operation unit can be moved to a first position to enable food to be stably placed on the platform and heated by the heating unit, and
wherein the operation unit can also be moved to a second position to contact the main body.

In one embodiment of the present invention, the operation unit at least has a keyboard.

In another embodiment of the present invention, the display unit at least has a display screen.

In yet another embodiment of the present invention, the main body is pivotally coupled to the operation unit.

In still another embodiment of the present invention, the heating unit is an electromagnetic coil.

In a further embodiment of the present invention, the notebook computer with a heating function further includes a heating control device disposed on the main body.

In a yet further embodiment of the present invention, the heating control device is disposed on the platform of the main body.

In a still further embodiment of the present invention, the platform of the main body has a recessed area, and the heating control device is disposed inside the recessed area.

In further another embodiment of the present invention, the main body has a status indicating unit presenting the status of the heating unit.

### BRIEF DESCRIPTION OF THE DRAWINGS

FIG. 1 is a perspective view schematically showing that a display unit is lifted up in a notebook computer with a heating function according to the present invention;

FIG. 2 is a perspective view schematically showing that a display unit together with an operation unit is lifted up in a notebook computer with a heating function according to the present invention;

FIG. 3 is a perspective view schematically showing that a notebook computer with a heating function according to the present invention is folded up;

FIG. 4 is a transparent top view schematically showing a main body of a notebook computer with a heating function according to the present invention;

FIG. 5 is a top view and a side view schematically showing a main body of a notebook computer with a heating function according to the present invention.

### DETAILED DESCRIPTION OF THE INVENTION

The embodiments are described in detail to demonstrate the technical contents of the present invention.

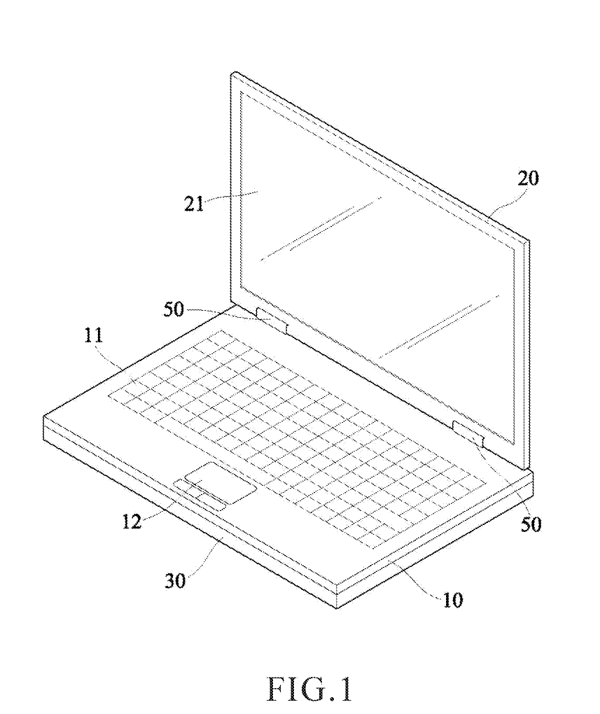

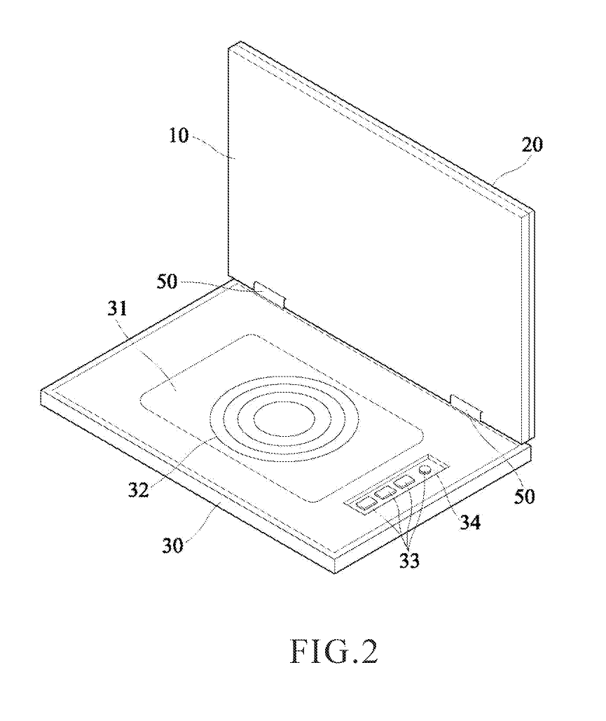

Refer to FIG. 1 and FIG. 2 perspective views schematically showing an opened notebook computer according to the present invention. The notebook computer with a heating function of the present invention comprises an operation unit 10, a display unit 20, and a main body 30. The operation unit 10 is arranged between the display unit 20 and the main body 30. The operation unit 10 at least includes a keyboard 11 and may further include a touch pad 12 and various specifications of connection ports (not shown in the drawings).

The display unit 20 is pivotally installed on a first side of the operation unit 10 via a pivotal element 50. The operation unit 10 can be opened from or closed to the display unit 20, as respectively shown in FIG. 1 and FIG. 2. The display unit 20 at least has a display screen 21.

From the drawings and description, it is known that the appearances of the operation unit 10 and display unit 20 of the present invention resemble those of the conventional notebook computers. However, the processing system, which drives the keyboard 11 and the display screen 21, is arranged inside the main body 30.

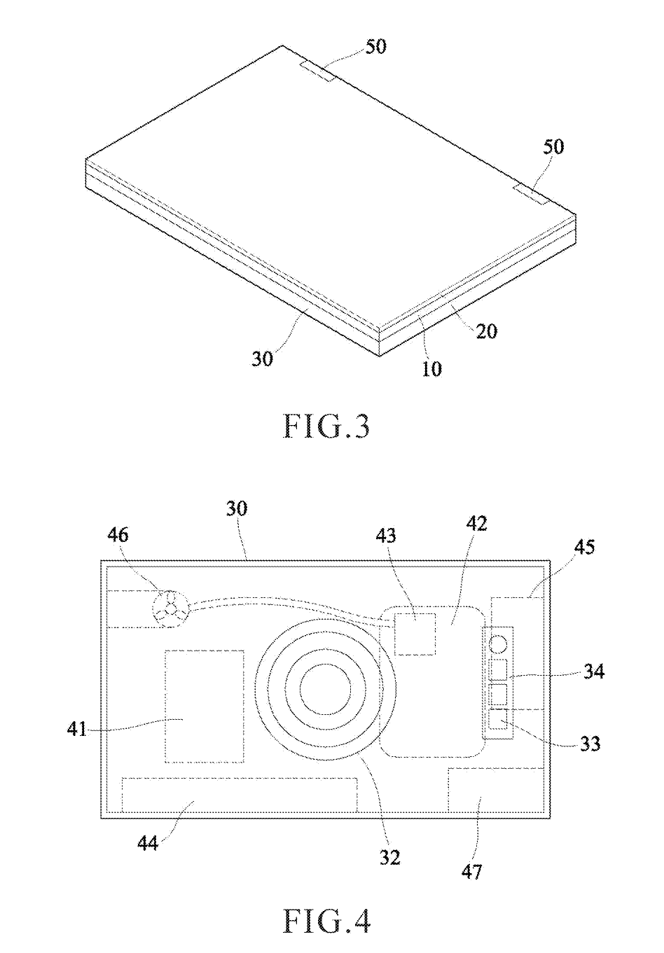

Via the pivotal element 50, the main body 30 is pivotally installed on a second side of the operation unit 10, wherein the second side of the operation unit 10 is opposite to first side of the operation unit 10. In other words, the notebook computer with a heating function of the present invention has a three-layer structure containing the display unit 20, the operation unit 10 and the main body 30 (shown in FIG. 3). The main body 30 has a platform 31 containing a heating unit 32.

Refer to FIG. 4. The components arranged inside the housing of the main body 30 includes a power supply 41, a motherboard 42, a central processing unit 43, a battery unit 44, an optical disc drive 45, an electric fan 46 and a hard disc drive 47, but the components inside the housing of the main body 30 are not limited to the abovementioned. The main body 30 further comprises a notebook computer processing system and a heating unit control system (not shown in the drawing). The notebook computer processing system includes the components enabling the operation unit 10 and display unit 20 to work, such as the power supply 41, motherboard 42, central processing unit 43, battery unit 44, optical disc drive 45, electric fan 46, hard disc drive 47, etc. The heating unit control system includes the components enabling the heating unit 32 of the main body 30 to work, such as the power supply 41, central processing unit 43, electric fan 46, etc. Both the notebook computer processing system and the heating unit control system share the power supply 41, central processing unit 43 and electric fan 46.

As mentioned above, the present invention is a three-layer structure formed of the display unit 20, the operation unit 10 and the main body 30. When not in use, they can be folded together to reduce the occupied space, as shown in FIG. 3. When the user intends to use the notebook computer function of the present invention, he can reveal the display screen 21 and the keyboard 11 to operate the computer via only lifting up the top-layer display unit 20, as shown in FIG. 1. When the user intends to cook or heat food, he can reveal the platform 31 of the bottom-layer main body 30 to heat food via lifting up the top-layer display unit 20 and the middle-layer operation unit 10 jointly, as shown in FIG. 2. Then, he places food on the platform 31 and uses the heating unit 32 to cook or heat the food. After the user has heated the food, he closes the display unit 20 and the operation unit 10 jointly to the main body 10.

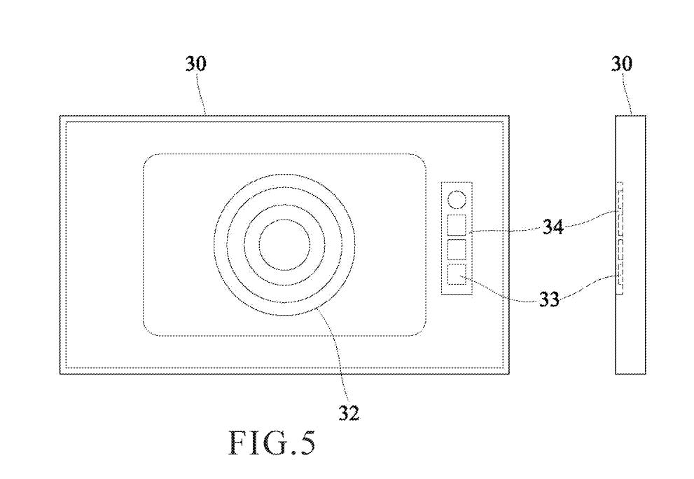

In the present invention, the heating unit 32 may be an electromagnetic heating coil or electromagnetic heating plate. The main body 30 further has a heating control device 33 for controlling the heating unit 32, such as a set of buttons or switches, and a status indicating unit presenting the status of the heating unit 32, such as a liquid crystal display. The heating control device 33 may be arranged on the platform 31 or on the side of the main body 30. To prevent from accidents caused by wrong operations or imprudent touches, a recessed area 34 is formed on the main body 30 or the platform 31, and the heating control device 33 is arranged inside the recessed area 34, as shown in FIG. 5.

In conclusion, the present invention artfully utilizes the existing components of a notebook computer to implement a heating function and realize a novel integration of a notebook computer and a heating function, whereby the user can conveniently use the heating unit of a notebook computer to heat or cook food. In the present invention, the operation unit 10 can be moved to a first position, and then food can be stably placed on the platform 31 and heated by the heating unit 32. Further, the operation unit 10 can also be moved to a second position to contact the main body 30 and conceal the platform 31.

In the present invention, the operation unit 10 is joined with the main body 30 when the heating function is not in use. Further, the operation unit 10 and the main body 30 may be locked together with one or more external or built-in locking devices.

The embodiments described above are only to exemplify the present invention but not to limit the scope of the present invention. Any equivalent modification or variation according to the specification or the claims of the present invention is to be also included within the scope of the present invention.

1. A notebook computer with a heating function, comprising,
an operation unit;
a display unit coupled to a first side of said operation unit and able to be opened from or closed to said operation unit; and
a main body coupled to a second side of said operation unit and having a platform with a heating unit;
wherein said second side is opposite to said first side, and
wherein said operation unit is arranged between the display unit and the main body and at least includes a keyboard and a touch pad;
wherein said operation unit can be moved to a first position to enable food to be stably placed on said platform and heated by said heating unit, and
wherein said operation unit can be moved to a second position to contact said main body;
wherein said heating unit is an electromagnetic heating coil.

2. The notebook computer with the heating function according to claim 1, wherein said operation unit includes a keyboard.

3. The notebook computer with the heating function according to claim 1, wherein said display unit includes a display screen.

4. The notebook computer with the heating function according to claim 1, wherein said operation unit is pivotally coupled to said main body.

5. (canceled)

6. The notebook computer with the heating function according to claim 1, further comprising a heating control device disposed on said main body.

7. The notebook computer with the heating function according to claim 6, wherein said heating control device is disposed on said platform of said main body.

8. The notebook computer with the heating function according to claim 6, wherein said platform of said main body has a recessed area, and said heating control device is disposed inside said recessed area.

9. The notebook computer with the heating function according to claim 1, wherein said main body has status indicating unit displaying status of said heating unit.
